(19) United States
(12) Patent Application Publication
(10) Pub. No.: US 2015/0139517 A1
(43) Pub. Date: May 21, 2015

(54) Methods And Systems For Calibration

(71) Applicant: University of Iowa Research Foundation, Iowa City, IA (US)

(72) Inventors: Gardar Sigurdsson, Iowa City, IA (US); Hans J. Johnson, Coralville, IA (US)

(21) Appl. No.: 14/541,942

(22) Filed: Nov. 14, 2014

Related U.S. Application Data
(60) Provisional application No. 61/904,660, filed on Nov. 15, 2013.

(51) Int. Cl. G06T 7/00

(52) U.S. Cl. CPC G06T 7/0012; G06T 2207/10081; G06T 2211/40
USPC 382/131

(57) ABSTRACT

The methods and systems for calibration are provided. For example, radiographic image density such as Hounsfield unit can be calibrated to facilitate tissue characterization of tumors or fluids when imaged at differing energy levels. The disclosed methods and systems can perform coronary calcium scanning at a radiation dose comparable to that of a chest X-ray or mammogram, and provide an accurate coronary calcium score as provided by a conventional high radiation coronary calcium scanning. An example method can comprise receiving first image data related to a first scan at a first energy level, receiving second image data related to a second scan at a second energy level, co-registering the first image data and the second image data, processing the co-registration of the first image data and the second image data to determine a calibration formula, and generating a score for the second image data based on the co-registration.

### CROSS REFERENCE TO RELATED PATENT APPLICATION

This application claims priority to U.S. Provisional Application No. 61/904,660 filed Nov. 15, 2013, herein incorporated by reference in its entirety

### BACKGROUND

Heart scans, also known as coronary calcium scans, provide pictures of coronary arteries. Coronary calcium scans use computed tomography (CT) to check for the buildup of calcium in plaque on the walls of the coronary arteries. Doctors use heart scans to look for calcium deposits in the coronary atherosclerosis that can narrow the arteries and increase the risk of heart attack. A coronary calcium score can be generated based on the heart scan. Calcium scoring by CT scanning can predict risk of heart attack, but due to radiation concerns it is not widely used. Current methods of using low energy imaging leads to erroneous overestimation of the coronary calcium score. There is a need for more sophisticated methods to produce an accurate coronary calcium score using low radiation imaging.

### SUMMARY

It is to be understood that both the following general description and the following detailed description are exemplary and explanatory only and are not restrictive, as claimed. Provided are methods and systems for calibration. For example, radiographic image density such as Hounsfield unit can be calibrated to facilitate tissue characterization of tumors or fluids when imaged at differing energy levels. As another example, a coronary calcium score can be calibrated by Hounsfield unit calibration disclosed herein.

An example method can comprise receiving first image data related to a first scan at a first energy level and receiving second image data related to a second scan at a second energy level. The first image data and the second image data can be co-registered. The co-registration of the first image data and the second image data can be processed to determine a calibration formula. A score for the second image data can be generated based on the calibration formula.

Another example method can comprise receiving image data related to a scan at a low energy level and determining a score for the image data elated to a scan at a low energy level. The score can be determined based on a calibration formula. In an aspect, the calibration formula can be determined based on one or more scans at one or more energy levels different from the low energy level.

An example system can comprise a scanner and a computing device coupled to the scanner. The scanner can be configured for performing a first scan at a first energy level and performing a second scan at a second energy level. The computing device can be configured for receiving first image data related to the first scan at the first energy level, receiving second image data related to the second scan at the second energy level, co-registering the first image data and the second image data, processing the co-registration of the first image data and the second image data to determine a calibration formula, and generating a score for the second image data based on the calibration formula.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a flowchart illustrating an example method for calibrating calcium score;

FIG. 2 is a flowchart illustrating another example method for generating a calibrated coronary calcium score;

FIG. 3 is a block diagram illustrating an example system environment in which the present systems and methods can operate;

FIG. 4 is a diagram illustrating scores of a plurality of hearts at different energy levels without calibration correction; and

FIG. 5 illustrates an example of a correlation graph to determine a calibration formula.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided are methods and systems for calibration. For example, radiographic image density such as Hounsfield unit (HU) can be calibrated to facilitate tissue characterization of tumors or fluids when imaged at differing energy levels. As another example, a coronary calcium score can be calibrated by Hounsfield unit (HU) calibration disclosed herein. The disclosed methods and systems can perform coronary calcium scanning at a radiation dose comparable to that of a chest X ray or mammogram, and can provide an accurate coronary calcium score as provided by a conventional high radiation coronary calcium scanning.

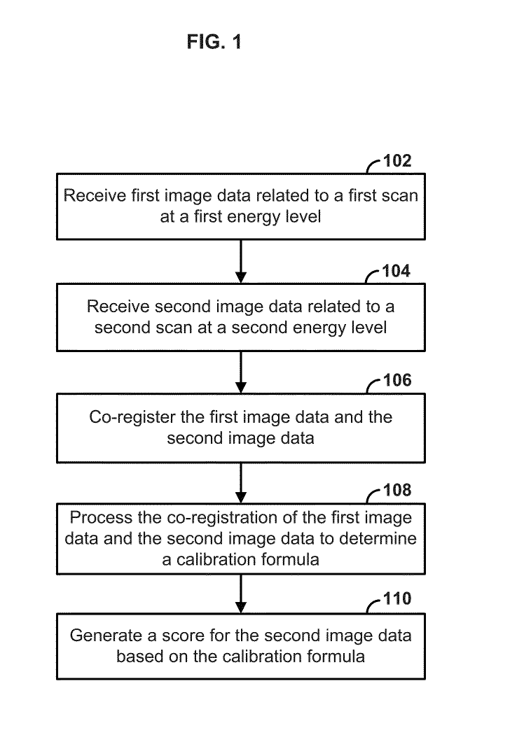

FIG. 1 is a flowchart illustrating an example method for calibrating a coronary calcium score. At step 102, first image data related to a first scan at a first energy level can be received. In an aspect, the first image data can comprise imaging data of a lesion in a tissue obtained in the first scan. For example, the image data can comprise data associated with a dimension, a geometry, a density, a location, a thickness of the lesion, combination thereof, and the like. As an example, the lesion can be a calcium deposit in a coronary artery. The first scan can be performed using a computed tomography (CT) scanner. In an aspect, the first energy level can be a “high” energy level. As used herein, “high” refers to an energy level that is greater than the energy level of a second scan. For example, the “high” energy level can be from about 120 kV to about 160 kV. For example, the “high” energy level can be 120 kV, 130 kV, 140 kV, 150 kV, 160 kV, or other suitable voltage levels. The first image data can be received by a computing device coupled to a scanner or other device capable of processing and/or storing the first image data.

At step 104, second image data related to a second scan at a second energy level can be received. In an aspect, the second image data can comprise imaging data of a lesion in a tissue obtained in the second scan. For example, the image data can comprise data associated with a dimension, a geometry, a density, a location, a thickness of the lesion, combinations thereof, and the like. As an example, the lesion can be a calcium deposit in a coronary artery. The second scan can be performed using a computed tomography (CT) scanner. In an aspect, the second energy level can be a “low” energy level. As used herein, “low” refers to an energy level that is less than the energy level of a first scan. As an example, the second energy level can be from about 70 kV to about 100 kV. For example, the second energy level can be 70 kV, 80 kV, 90 kV, 100 kV, or other suitable voltage levels. The second image data can be received by a computing device coupled to a scanner or other device capable of processing and/or storing the second image data.

At step 106, the first image data and the second image data can be co-registered. In an aspect, the co-registration can be a two or three dimensional co-registration. As an example, co-registration can be performed by placing the first image data and the second image data into one coordinate system. Point-to-point correspondence can be matched between the first image data and the second image data. In an aspect, co-registration can comprise intensity-based registration, feature-based registration or a combination of the intensity-based and feature-based registration. As an example, the intensity-based registration can compare intensity patterns (e.g., density of calcification) between the first image and the second image. As another example, feature-based registration can correspond between image features such as specific points, lines, contours, and voxels between the first image and the second image. In an aspect, the co-registration can comprise registering the entire first image and second image (e.g., image of a tissue or organ). In another aspect, the co-registration can comprise registering portion of the first image and second image (e.g., image of a lesion or calcification area). As an example, the correspondence between specific points, lines, contours, voxels, and density patterns of the first image and the second image can map the two images into one coordinate system, thereby establish a point-by-point correspondence between the first and second image.

At step 108, the co-registration of the first image data and the second image data can be processed to determine a calibration formula.

In an aspect, processing the co-registration of the first image data and the second image data can comprise determining a minimum density threshold (e.g., minimum HU) between the first image data (e.g., high energy level scan data) and the second image data (e.g., low energy level scan data) that allows equalization of volume and/or area of a lesion between the first image data and the second image data. The minimum density threshold determination process can be an iterative process. For example, the process can start with 130 HU as an initial density threshold. In an aspect, a lower energy level scan would be expected to have a larger area and/or volume of calcium at the initial density threshold (e.g., 130 HU). By gradually increasing the density threshold to a higher number (e.g., 167 HU), the area and/or volume between the first image data and the second image data can become equal. In an aspect, the density threshold determination process can be applied for image data associated with multiple lesions at the two energy levels (e.g., first energy level, second energy level). A median value can be used as a density threshold to determine density values in image data associated with the first image data and the second image data. In an aspect, the density threshold determination process can be a semi-automatic or an automatic process.

In an aspect, the iterative process for detecting the minimum density threshold can be used for assessing the lowest density value for each of a plurality of weighing factor categories (e.g., 130-199 HU, 200-299 HU, 300-399 HU, 400 HU and greater). By using the iterative process for each of the plurality of weighing categories, the calibration can be more robust in accuracy.

In an aspect, the highest density value generated in the second coronary calcium scan can be different from the highest density value generated in the first coronary calcium scan using the determined density threshold (e.g., 167 HU). As such, coronary calcium score of the second scan can be different from coronary calcium score of the first scan. In an aspect, a linear correction (e.g. best fit linear correction) (A=x+y(B)) or a non-linear logarithmic correction (e.g., best fit non-linear logarithmic correction) (A=x+log y(B)) can be used to calibrate the first image density data and the second image density data. Specifically, the first image density data and the second image density data can be scatter plotted and co-registered to obtain voxel to voxel based correlation. As a specific example, a set of voxels with density (e.g., Hounsfield units) greater than a predefined density threshold (e.g., 167 HU) can be identified in the first image. The corresponding voxels can be identified in the second image. The density data (e.g., a set of voxels) in the first image can be scatter plotted against density data (e.g., a set of voxels) in the second image. The slope and intercept of the plot can be calculated respectively. A calibration formula can be determined based on the slope and intercept. As an example, the calibration formula can be in the form of a value (e.g., a density) in the first image=a value (e.g., a density) in the second image times A plus B, wherein A is the slope and B is the intercept. According to the calibration formula, for example, in a coronary calcium scan, the highest density of 200 HU at first energy level (e.g., 120 kV) would be 267 HU at the second energy level (e.g., 80 kV). As a result, new weighting factor can be assigned to the density of coronary calcification. For example, a coronary calcium score weighting factor of 1 can be assigned for 167-265 HU, 2 for 266-408 HU, 3 for 409-550 HU, and 4 for 551 HU and greater according to the calibration formula. In an aspect, the score of the second image can be calibrated according to the calibration formula. The calibrated score of the second image can be the same as the score of the first image.

In an aspect, the calibration formula can be specific for the type of scanner, as different X-ray generators can have different energy profiles. In other words, once the calibration formula is determined for a specific type of scanner, it can be used for generating a score generated for image data obtained by the specific type of scanner.

In an aspect, calibration formula for a scanner or a type of scanner can be determined via a semi-automatic process or an automatic process. For example, image data associated with a phantom can be acquired via a scanner or a type of scanner at different energy levels (e.g., 80 KV, 100 KV, 120 KV, etc.). In an aspect, image data such as volume, area, density of the phantom can be obtained. A calibration formula can be determined based on the image data associated with the phantom. Then the determined calibration formula can be used to perform calibration in real tissue scanning for the scanner or the type of scanner.

At step 110, a score for the second image data can be generated based on the calibration formula. In an aspect, a coronary calcium score can be calculated using a weighting factor assigned to the highest density of calcification in a coronary calcium lesion. For example, without calibration, a coronary calcium score weighting factor of 1 can be assigned for 130-199 HU, 2 for 200-299 HU, 3 for 300-399 HU, and 4 for 400 HU and greater. The weighting factor assigned to the highest density of calcification in a coronary calcium lesion can be adjusted based on a calibration formula. For example, based on a calibration formula, a coronary calcium score weighting factor of 1 can be assigned for 167-265 HU, 2 for 266-408 HU, 3 for 409-550 HU, and 4 for 551 HU and greater. In an aspect, the weighted score can then be multiplied by the area (e.g., in square millimeters or in pixels) of the coronary calcification. As a result, a score for the second image data can be generated based on the calibration formula. As an example, the area of the coronary calcification can be determined based on the area with minimum of 3 adjacent pixels above density of 130 HU. For example, a coronary calcification could measure 5 square millimeters and have a highest density of 350 Hounsfield units (HU). The coronary calcium score would therefore be 10 (5 square millimeters×weighted score of 2). As another example, assuming a coronary calcification area of 5 pixels and a peak calcium measurement of 350 HU, the coronary calcium score would be 10 (5 pixels×weighted score of 2). In another aspect, a plurality of tomographic images can be generated to cover the entire thickness of the tissue of an organism, e.g., 50-60. In an aspect, a coronary calcium score can be generated for each of the plurality of tomographic images. A total score can then be generated by summing up the coronary calcium score of each of the plurality of tomographic images.

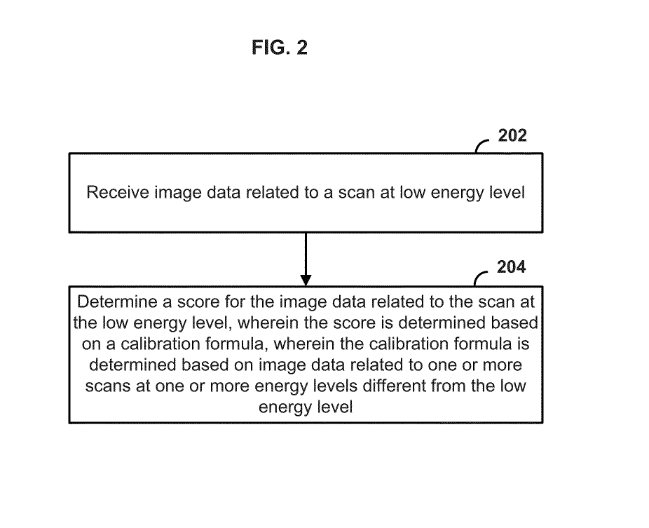

FIG. 2 is a flowchart illustrating an example method for generating a calibrated coronary calcium score. At step 202, image data that relates to a scan at a low energy level can be received. As an example, image data related to a coronary calcium scan can be received by a computer from a scanner (e.g., CT scanner). In an aspect, the image data can relate to a scan of cadaver coronary arteries, for example, in paraffin cast. As used herein, low energy level refers to an energy level that is less than a standard energy level in practice. As an example, the low energy level can be from about 70 kV to about 100 kV for a CT scanner. For example, the low energy level can be 70 kV, 80 kV, 90 kV, 100 kV, or other suitable voltage levels, whereas the standard energy level can be 120 kV.

At step 204, a score for the image data related to the scan at the low energy level can be determined. In an aspect, the score for the image data related to the scan at the low energy level can be determined based on a calibration formula. In an aspect, the calibration formula can be determined based on one or more scans at one or more energy levels different from the low energy level. For example, the one or more energy levels different from the low energy level can be from about 120 kV to about 160 kV. For example, the one or more energy levels can be 120 kV, 130 kV, 140 kV, 150 kV, 160 kV, or other suitable voltage levels.

In an aspect, a calibration formula can be determined by co-registering the image data related to the scan at the low energy level (e.g., 80 kV) and image data related to the one or more scans at one or more energy levels (e.g., 120 kV, 140 kV, etc.) different from the low energy level. In an aspect, the score for the image data at the low energy level can be determined based on the calibration formula. As an example, co-registration can comprise intensity-based registration, feature-based registration, or a combination of intensity-based and feature-based registration. As an example, the intensity-based registration can compare intensity patterns (e.g., density of calcification) between images. As another example, the feature-based registration can correspond between image features such as specific points, lines, contours, and voxels. In an aspect, the co-registration can register entire images (e.g., image of a tissue or organ) related to the scan at the low energy level and the respective one or more scans at the one or more energy levels different from the low energy level. In another aspect, the co-registration can register a portion of the image related to the scan at the low energy level and respective portions of images (e.g., image of a lesion or calcification area) related to the one or more scans at the one or more energy levels different from the low energy level. As an example, the correspondence between specific points, lines, contours, voxels, and density patterns of the image related to the scan at the low energy level and the images related to the one or more scans at the one or more energy levels can map multiple co-registered images into one coordinate system, thereby establish a point-by-point correspondence between the image related to the scan at the low energy level and the respective images related to the one or more scans at the one or more energy levels different from the low energy level.

As an example, the radiographic image density value generated in a low energy level coronary calcium scan can be different from the radiographic image density value generated in a higher energy level coronary calcium scan. As such, the radiographic image density such as Hounsfield unit can be calibrated based on the calibration formula.

In an aspect, processing the co-registration of the image data of a scan at the low energy level and the image data of the one or more scans at the one or more energy levels different from the low energy level can comprise determining a minimum density threshold (e.g., minimum HU) between the image data of a scan at the low energy level and the image data of the one or more scans at the respective one or more energy levels different from the low energy level. The determined threshold allows equalization of volume and/or area of a lesion between the image data of a scan at the low energy level and the image data of the one or more scans at the one or more energy levels different from the low energy level. The minimum density threshold determination process can be an iterative process. For example, the process can start with 130 HU as an initial density threshold. In an aspect, a lower energy level scan would be expected to have a larger area and/or volume of calcium at the initial density threshold (e.g., 130 HU). By gradually increasing the density threshold to a higher number (e.g., 167 HU), the area and/or volume between the image data at the low energy level and the image data at one or more energy levels different from (e.g., higher than) the lower energy level can become equal. In an aspect, the density threshold determination process can be applied for image data associated with multiple lesions at the two energy levels (e.g., a lower energy level, a higher energy level). A median value of multiple thresholds related to multiple lesions can be used as a density threshold. In an aspect, the density threshold determination process can be a semi-automatic or an automatic process.

In an aspect, the iterative process for detecting the minimum density threshold can be used for assessing the lowest density value for each of a plurality of weighing factor categories (e.g., 130-199 HU, 200-299 HU, 300-399 HU, 400 HU and greater). By using the iterative process for each of the plurality of categories, the calibration can be more robust in accuracy.

In an aspect, a linear correction (e.g., best fit linear correction) (A=x+y(B)) or a non-linear logarithmic linear correction (e.g., best fit log-linear correction) (A=x+log(y(B))) can be used to calibrate the radiographic image density data associated with the low energy level and one or more energy levels different from the low energy level. Specifically, the radiographic image density data associated with the low energy level and radiographic image density data associated with one or more energy levels different from the low energy level can be scatter plotted and aligned to obtain voxel to voxel based correlation. As a specific example, a set of voxels with density (e.g., Hounsfield units) greater than a predefined threshold (e.g., 130 HU) can be identified in the image at the low energy level. A set of voxels that corresponds to the set of identified voxels at the low energy level can be identified in respective images at the one or more energy levels different from the low energy level. The density data of voxels associated the image at the low energy level can be scatter plotted against the density data of voxels associated with the respective images at the one or more energy levels different from the low energy level. The slope and intercept of the plot can be calculated. The calibration formula can be determined based on the slope and intercept. As an example, the calibration formula can be in the form of a new score equals to an original score times A plus B, wherein A is the slope and B is the intercept of the plot.

In an aspect, a score of the image data related to the low energy level can be determined based on the calibration formula. As an example, based on the calibration formula, in a coronary calcium scan, density of 267 HU at a low energy level (e.g., 80 kV) would be 200 HU at a higher energy level (e.g., 120 kV). As a result, new weighting factor can be assigned to the density of coronary calcification. For example, a coronary calcium score weighting factor of 1 can be assigned for 167-265 HU, 2 for 266-408 HU, 3 for 409-550 HU, and 4 for 551 HU and greater. For example, for a coronary calcification that measures 5 square millimeters and have a highest density of 350 Hounsfield units (HU). The coronary calcium score would therefore be 10 (5 square millimeters×weighted score of 2). A total score can then be generated by summing up the coronary calcium score of each of the plurality of tomographic images.

In an aspect, the calibration formula can be specific for the type of scanner, as different X-ray generators can have different energy profiles. In other words, once the calibration formula is determined for a specific type of scanner, it can be used for generating a score generated for image data obtained by the specific type of scanner.

In an aspect, score determination for a scanner or a type of scanner can be an automatic process. For example, image data associated with a phantom can be acquired via a scanner or a type of scanner at different energy levels (e.g., 80 KV, 100 KV, 120 KV, etc.). In an aspect, geometry data (e.g., volume, area) and density data of a phantom can be obtained and calibrated according to the method disclosed herein. A calibration formula can be determined based on the image data associated with the phantom. Then the calibration formula can be used to perform calibration in real tissue scanning for the scanner or the type of scanner as described in step 204.

In an aspect, the disclosed method can be used in other tissue characterization scans. As an example, the method can be used in the scan of pleural fluid to determine serous fluid versus hemorrhagic fluid. As another example, the method can be used in the scan of pericardial fluid to determine serous fluid versus hemorrhagic fluid. As another example, the method can be used in the scan of characterization of tumors or masses. As another example, the method can be used in the scan for characterization of kidney stones.

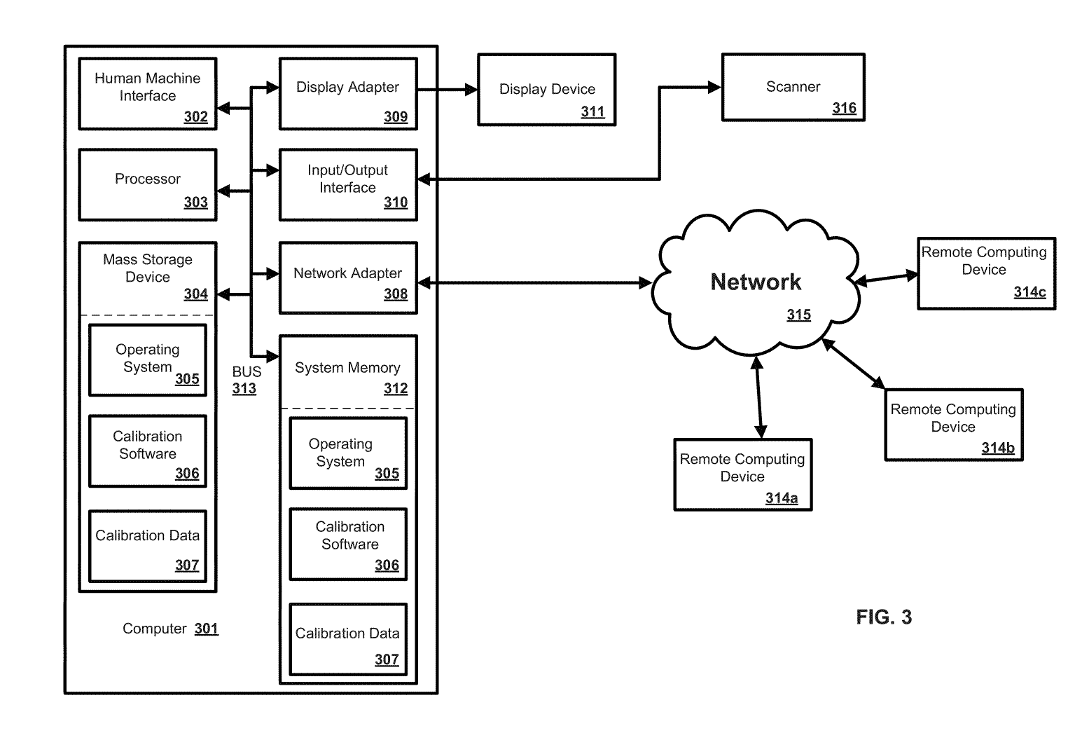

In an exemplary aspect, the methods and systems can be implemented on a computer 301 as illustrated in FIG. 3 and described below. Similarly, the methods and systems disclosed can utilize one or more computers to perform one or more functions in one or more locations. FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or a combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312. In the case of multiple processing units 303, the system can utilize parallel computing.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 313, and all buses specified in this description can also be implemented over a wired or wireless network connection and each of the subsystems, including the processor 303, a mass storage device 304, an operating system 305, calibration software 306, calibration data 307, a network adapter 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as calibration data 307 and/or program modules such as operating system 305 and calibration software 306 that are immediately accessible to and/or are presently operated on by the processing unit 303.

In another aspect, the computer 301 can also comprise other removable/non-removable, volatile/non-volatile computer storage media. By way of example, FIG. 3 illustrates a mass storage device 304 which can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and calibration software 306. Each of the operating system 305 and calibration software 306 (or some combination thereof) can comprise elements of the programming and the calibration software 306. Calibration data 307 can also be stored on the mass storage device 304. Calibration data 307 can be stored in any of one or more databases known in the art. Examples of such databases comprise, DB2®, Microsoft® Access. Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 301 via Input/Output Interface 310. Any step and/or result of the methods can be output in any form to an output device. Such output can be any form of visual representation, including, but not limited to, textual, graphical, animation, audio, tactile, and the like. The display 311 and computer 301 can be part of one device, or separate devices.

The computer 301 can operate in a networked environment using logical connections to one or more remote computing devices 314a,b,c. By way of example, a remote computing device can be a personal computer, portable computer, smartphone, a server, a router, a network computer, a peer device or other common network node, and so on. Logical connections between the computer 301 and a remote computing device 314a,b,c can be made via a network 315, such as a local area network (LAN) and/or a general wide area network (WAN). Such network connections can be through a network adapter 308. A network adapter 308 can be implemented in both wired and wireless environments. Such networking environments are conventional and commonplace in dwellings, offices, enterprise-wide computer networks, intranets, and the Internet.

In an aspect, the computer 301 can be coupled to a scanner 316. As an example, the scanner 316 can be a CT scanner. The scanner 316 can be configured for performing scans at a plurality of energy levels. As an example, the scanner 316 can be a CT scanner configured for performing a CT scan at a plurality of energy levels (e.g., 80-100 kV level, 120 kV level).

In an aspect, the computer 301 can be configured for receiving first image data related to a first scan at the first energy level from the scanner 316, receiving second image data related to a second scan at the second energy level from the scanner 316, co-registering the first image data and the second image data, processing the co-registration of the first image data and the second image data to determine a calibration formula, generating a score for the second image data based on the calibration formula. As an example, the co-registration, score generation and calibration formula determination can be achieved using the calibration software 306.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of calibration software 306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

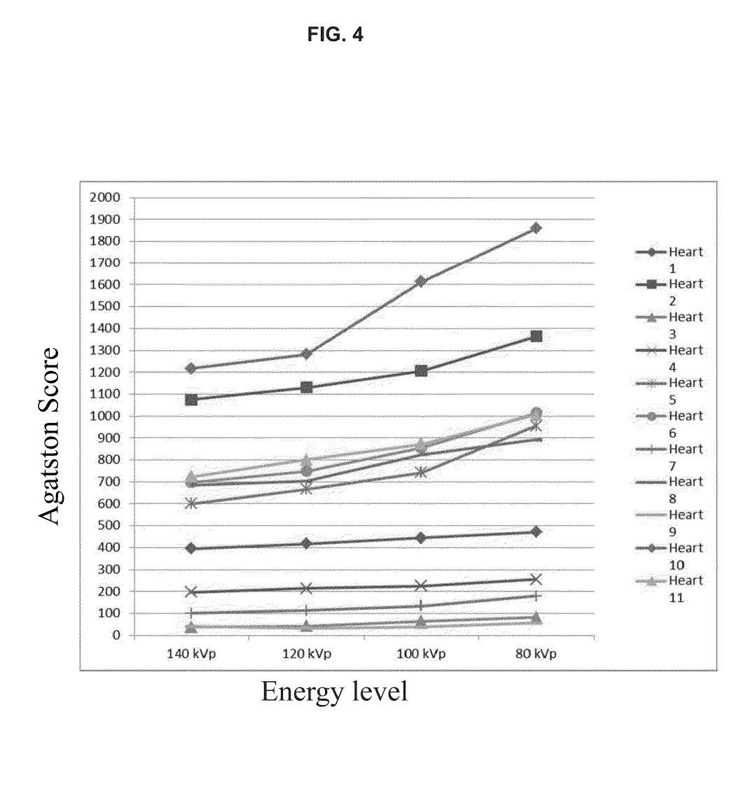

As an example, eleven cadaver hearts were scanned at 140 kV, 120 kV, 100 kV and 80 kV, respectively. FIG. 4 illustrates Agatston Score (AS) of eleven cadaver hearts at four different energy levels using a standard Agatston threshold 130 HU. Agatston score (AS) and calcium volume (CaV) were measured using a standard scanner software with a minimum threshold of 130 HU. FIG. 4 shows how lower energy scans can have systematic increase in AS. Same systematic increase was seen in CaV, but not shown in FIG. 4.

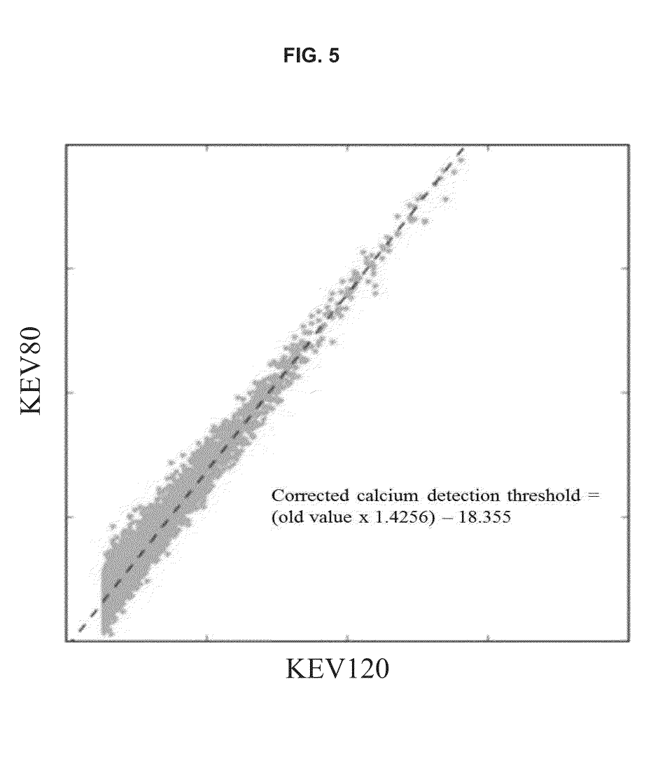

FIG. 5 illustrates an example correlation graph used to calculate a calibration formula. The density data of voxels associated the image at 80 KV and a corresponding image at 120 KV can be scatter plotted. Three-dimensional co-registration was used to develop a new calcium detection threshold. Specifically, 167 HU is the threshold used for the 80 kV image. For example, the threshold of 167 HU was found by using linear correlation graph formula determined via the co-registered image data associated with the 80 and 120 kV scans. The value of 130 HU in 120 kV scan was multiplied with slope 1.4256 and then subtracted by intercept 18.355, resulting in the value 166.973 or 167. AS and CaV were then re-measured using the respective new calcium thresholds (e.g., 147 HU, 167 HU). Then AS mean and CaV mean were calculated based on the re-measured AS and CaV.

Table 1 illustrates effect of minimum calcium detection threshold (HU) on Agatston score (AS) at different energy levels. It is known that a stepwise decline in energy level (voltage) produced a stepwise increase in AS and CaV. An application of a 147 HU threshold at 100 kV reduced the increase in AS and CaV to a non-significant level, compared to 120 kV scans. An application of a 167 HU threshold at 80 kV reduced the difference compared to 120 kV scans, but the difference remained statistically significant, as shown in Table 1.

TABLE 1

| kV/Threshold | Agatston Score Mean | Calcium Volume Mean |
|---|---|---|
| 120 kV/130 HU | 334.86 (128.15) | 262.67 (100.66) |
| 100 kV/147 HU | 353.44 (135.26)* | 266.16 (103.16)* |
| 80 kV/167 HU | 388.04 (148.50)** | 285.46 (107.68)** |
| (vs. 120 kV/130 HU) | *p = 0.192 | *p > 0.99 |
| (vs. 120 kV/130 HU) | **p = 0.0002 | **p = 0.011 |

A linear mixed model analysis was used to compare AS mean and CaV mean at different energy levels. P-values were calculated for pairwise comparisons using Bonferroni's method. To normalize data distribution, a natural log transformation was applied to the data distribution. The estimated means from the log scale were then back transformed to obtain the means in the original scale.

It can be seen that low energy image acquisition protocol with 80 kV can lead to an overestimation of AS that is not corrected by changing only the lowest weighing factor limit or minimum detection threshold for calcium. Correction of all weighing factor limits can be a solution to eliminate the systematic changes in AS with low energy protocols. There was also systematic increase in volume with change in lowest weighing factor. The lowest weighing factor limit (minimum detection threshold) can be a key determinant of volume. As volume measurements are integral to calculation of calcium mass, determining the lowest weighing factor limit (minimum detection threshold) can be an important step in the assessment of coronary calcium.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving first image data related to a first scan at a first energy level;
receiving second image data related to a second scan at a second energy level;
co-registering the first image data and the second image data;
processing the co-registration of the first image data and the second image data to determine a calibration formula; and
generating a score for the second image data based on the calibration formula.

2. The method of claim 1, wherein the image data comprises data associated with one or more of a dimension, a geometry, a density, a location, and a thickness of a lesion.

3. The method of claim 2, wherein the lesion comprises a calcium deposit.

4. The method of claim 2, wherein processing the co-registration of the first image data and the second image data comprises determining a minimum density threshold.

5. The method of claim 1, wherein the second energy level is lower than the first energy level.

6. The method of claim 1, wherein co-registering of the first image data and the second image data comprises intensity-based registration, feature-based registration, or a combination thereof.

7. The method of claim 1, wherein processing the co-registration of the first image data and the second image data comprises performing a linear correction, a non-linear logarithmic correction, or a combination thereof, based on the first image data and the second image data.

8. A method comprising:
receiving image data related to a scan at a low energy level; and
determining a score for the image data related to the scan at the low energy level, wherein the score is determined based on a calibration formula, wherein the calibration formula is determined based on image data related to one or more scans at one or more energy levels different from the low energy level.

9. The method of claim 8, wherein the image data comprises data associated with one or more of a dimension, a geometry, a density, a location, and a thickness of a lesion.

10. The method of claim 8, wherein the scan is a coronary calcium scan.

11. The method of claim 8, wherein the scan is a computed tomography scan.

12. The method of claim 8, wherein the calibration formula is determined by co-registering the image data related to the scan at the low energy level and the image data related to the one or more scans at the one or more energy levels different from the low energy level.

13. The method of claim 12, wherein the co-registering the image data related to the scan at the low energy level and the image data related to the one or more scans at the one or more energy levels different from the low energy level comprises intensity-based registration, feature-based registration, or a combination thereof.

14. The method of claim 8, wherein the calibration formula is determined via a linear correction, a non-linear logarithmic correction, or a combination thereof, based on the image data related to the scan at the low energy level and the image data related to the one or more scans at the one or more energy levels different from the low energy level.

15. A system comprising:
a scanner, configured for,
performing a first scan at a first energy level, and
performing a second scan at a second energy level; and
a computing device, coupled to the scanner, configured for.
receiving first image data related to the first scan at the first energy level;
receiving second image data related to the second scan at the second energy level;
co-registering the first image data and the second image data;
processing the co-registration of the first image data and the second image data to determine a calibration formula; and
generating a score for the second image data based on the calibration formula.

16. The system of claim 15, wherein the image data comprises data associated with one or more of a dimension, a geometry, a density, a location, and a thickness of a lesion.

17. The system of claim 16, wherein the lesion comprises a calcium deposit.

18. The system of claim 16, wherein processing the co-registration of the first image data and the second image data comprises determining a minimum density threshold.

19. The system of claim 15, wherein the second energy level is lower than the first energy level.

20. The system of claim 15, wherein co-registering of the first image data and the second image data comprises intensity-based registration, feature-based registration, or a combination thereof.
